(19) United States
(12) Patent Application Publication
(10) Pub. No.: US 2024/0257021 A1
(43) Pub. Date: Aug. 1, 2024

(54) PREDICTION OF AND SUPPORT READINESS FOR FUTURE BUSINESS INTENTS

(71) Applicant: Dell Products L.P., Round Rock, TX (US)

(72) Inventors: Stephen James Todd, North Andover, MA (US); Eloy Francisco Macha, Crowley, TX (US); Robert Anthony Lincourt, JR., Franklin, MA (US)

(21) Appl. No.: 18/162,239

(22) Filed: Jan. 31, 2023

(51) Int. Cl. G06Q 10/0639; G06Q 10/0637; G06Q 10/067

(52) U.S. Cl. CPC G06Q 10/0639; G06Q 10/06375; G06Q 10/067

(57) ABSTRACT

A method and system for the prediction of and support readiness for future business intents. A current business intent may generally refer to information, respective to an organization user, which may pertain to or describe any historical and/or up-to-date engagement(s) of the organization user within and/or outside their organization. Said information may be reflected through a set of business intent parameters. A future business intent may specify predictions outlining a possible or potential evolution in one or more of said business intent parameters. Embodiments disclosed herein construct and employ a machine learning model to extrapolate future business intent(s), based on the current business intent, for an organization user; and pursues a readiness pipeline bridging the current business intent to any future business intent, thereby readying support that the organization user may rely upon should the organization user follow the predictions, specified by any future business intent, at some future point-in-time.

### BACKGROUND

Organization strategy may reference a plan (or a sum of actions), intended to be pursued by an organization, directed to leveraging organization resources towards achieving one or more long-term goals. Said long-term goal(s) may, for example, relate to identifying or predicting future or emergent trends across one or more industries. Digitally-assisted organization strategy, meanwhile, references the scheming and/or implementation of organization strategy, at least in part, through insights distilled by artificial intelligence.

### SUMMARY

In general, in one aspect, embodiments disclosed herein relate to a method for extrapolating prospective user business intents. The method includes: identifying an organization user; obtaining a user business intent for the organization user; building an intent predictive model based on the user business intent; extrapolating, using the intent predictive model, a prospective user business intent for the organization user; and pursuing an inter-intent roadmap for the prospective user business intent.

In general, in one aspect, embodiments disclosed herein relate to a non-transitory computer readable medium (CRM). The non-transitory CRM includes computer readable program code, which when executed by a computer processor, enables the computer processor to perform a method for extrapolating prospective user business intents. The method includes: identifying an organization user; obtaining a user business intent for the organization user; building an intent predictive model based on the user business intent; extrapolating, using the intent predictive model, a prospective user business intent for the organization user; and pursuing an inter-intent roadmap for the prospective user business intent.

In general, in one aspect, embodiments disclosed herein relate to a system. The system includes: an insight service including a computer processor configured to perform a method for extrapolating prospective user business intents. The method includes: identifying an organization user; obtaining a user business intent for the organization user; building an intent predictive model based on the user business intent; extrapolating, using the intent predictive model, a prospective user business intent for the organization user; and pursuing an inter-intent roadmap for the prospective user business intent.

Other aspects disclosed herein will be apparent from the following description and the appended claims.

### BRIEF DESCRIPTION OF DRAWINGS

FIG. 1A shows a system in accordance with one or more embodiments disclosed herein.

FIG. 1B shows a client device in accordance with one or more embodiments disclosed herein.

FIG. 2A shows an example connected graph in accordance with one or more embodiments disclosed herein.

FIGS. 2B-2D show example k-partite connected graphs in accordance with one or more embodiments disclosed herein.

FIG. 3A shows a flowchart describing a method for the prediction of and support readiness for future business intents in accordance with one or more embodiments disclosed herein.

FIG. 3B shows a flowchart describing a method for pursuing an inter-intent roadmap in accordance with one or more embodiments disclosed herein.

FIG. 4 shows an example computing system in accordance with one or more embodiments disclosed herein.

FIG. 5 shows an example scenario in accordance with one or more embodiments disclosed herein.

### DETAILED DESCRIPTION

Specific embodiments disclosed herein will now be described in detail with reference to the accompanying figures. In the following detailed description of the embodiments disclosed herein, numerous specific details are set forth in order to provide a more thorough understanding disclosed herein. However, it will be apparent to one of ordinary skill in the art that the embodiments disclosed herein may be practiced without these specific details. In other instances, well-known features have not been described in detail to avoid unnecessarily complicating the description.

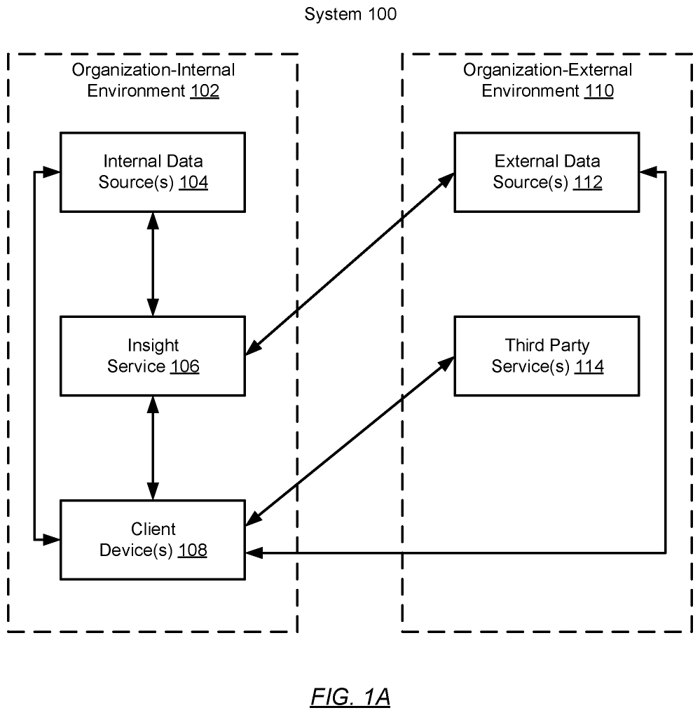

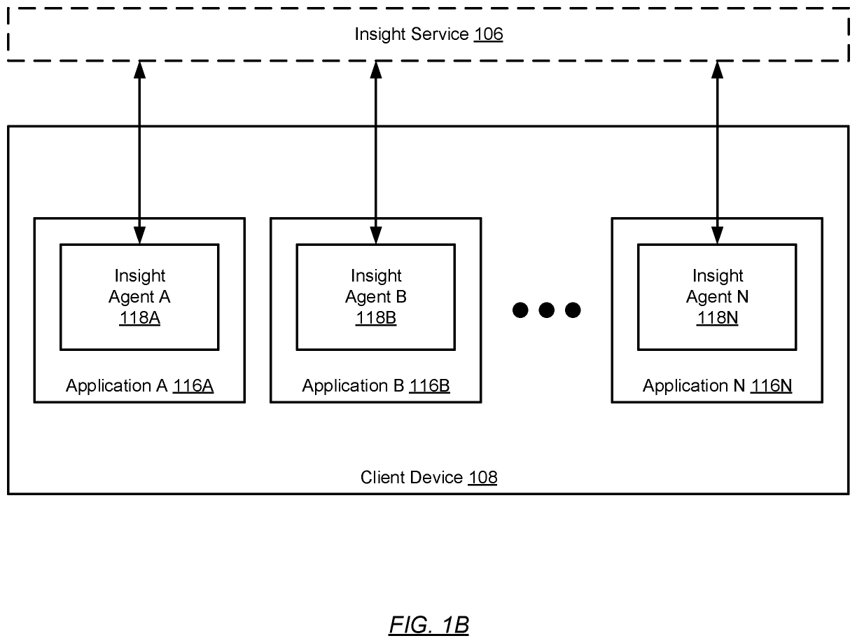

In the following description of FIGS. 1A-5, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

In general, embodiments disclosed herein relate to the prediction of and support readiness for future business intents. A current business intent may generally refer to information, respective to an organization user, which may pertain to or describe any historical and/or up-to-date engagement(s) of the organization user within and/or outside their organization. Said information, further, may be reflected through a set of business intent parameters. A future business intent, meanwhile, may specify predictions outlining a possible or potential evolution in one or more of said business intent parameters. Embodiments disclosed herein, accordingly, construct and employ a machine learning model to extrapolate future business intent(s), based on the current business intent, for an organization user; and, moreover, pursues a readiness pipeline bridging the current business intent to any future business intent, thereby readying support that the organization user may rely upon should the organization user follow the predictions, specified by any future business intent, at some future point-in-time.

FIG. 1A shows a system in accordance with one or more embodiments disclosed herein. The system (100) may include an organization-internal environment (102) and an organization-external environment (110). Each of these system (100) components is described below.

In one or many embodiment(s) disclosed herein, the organization-internal environment (102) may represent any digital (e.g., information technology (IT)) ecosystem belonging to, and thus managed by, an organization. Examples of said organization may include, but are not limited to, a business/commercial entity, a higher education school, a government agency, and a research institute. The organization-internal environment (102), accordingly, may at least reference one or more data centers of which the organization is the proprietor. Further, the organization-internal environment (102) may include one or more internal data sources (104), an insight service (106), and one or more client devices (108). Each of these organization-internal environment (102) subcomponents may or may not be co-located, and thus reside and/or operate, in the same physical or geographical space. Moreover, each of these organization-internal environment (102) subcomponents is described below.

In one or many embodiment(s) disclosed herein, an internal data source (104) may represent any data source belonging to, and thus managed by, the above-mentioned organization. A data source, in turn, may generally refer to a location where data or information (also referred to herein as one or more assets) resides. An asset, accordingly, may be exemplified through structured data/information (e.g., tabular data/information or a dataset) or through unstructured data/information (e.g., text, an image, audio, a video, an animation, multimedia, etc.). Furthermore, any internal data source (104), more specially, may refer to a location that stores at least a portion of the asset(s) generated, modified, or otherwise interacted with, solely by entities (e.g., the insight service (106) and/or the client device(s) (108)) within the organization-internal environment (102). Entities outside the organization-internal environment may not be permitted to access any internal data source (104) and, therefore, may not be permitted to access any asset(s) maintained therein.

Moreover, in one or many embodiment(s) disclosed herein, any internal data source (104) may be implemented as physical storage (and/or as logical/virtual storage spanning at least a portion of the physical storage). The physical storage may, at least in part, include persistent storage, where examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one or many embodiment(s) disclosed herein, the insight service (106) may represent information technology infrastructure configured for digitally-assisted organization strategy. In brief, organization strategy may reference a plan (or a sum of actions), intended to be pursued by an organization, directed to leveraging organization resources towards achieving one or more long-term goals. Said long-term goal(s) may, for example, relate to identifying or predicting future or emergent trends across one or more industries. Digitally-assisted organization strategy, meanwhile, references the scheming and/or implementation of organization strategy, at least in part, through insights distilled by artificial intelligence. An insight, in turn, may be defined as a finding (or more broadly, as useful knowledge) gained through data analytics or, more precisely, through the discovery of patterns and/or relationships amongst an assortment of data/information (e.g., assets). The insight service (106), accordingly, may employ artificial intelligence to ingest assets maintained across various data sources (e.g., one or more internal data sources (104) and/or one or more external data sources (112)) and, subsequently, derive or infer insights therefrom that are supportive of an organization strategy for an organization.

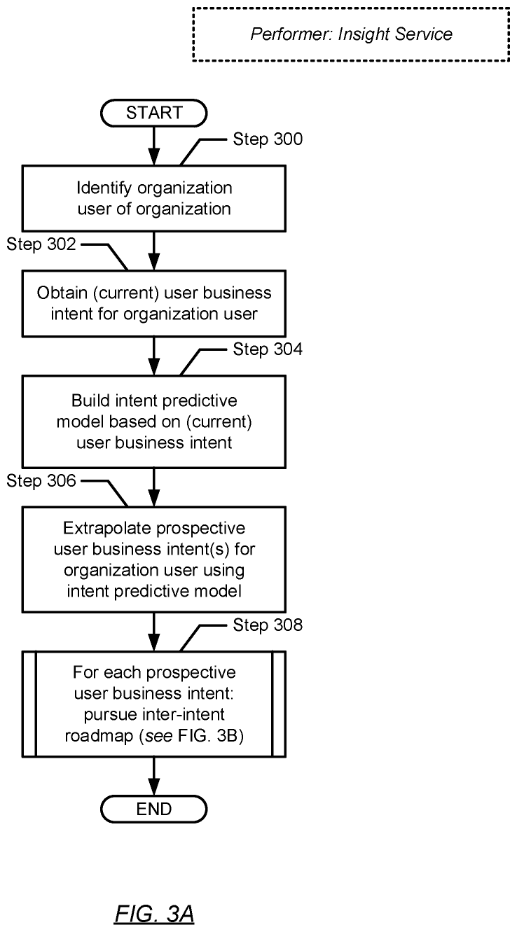

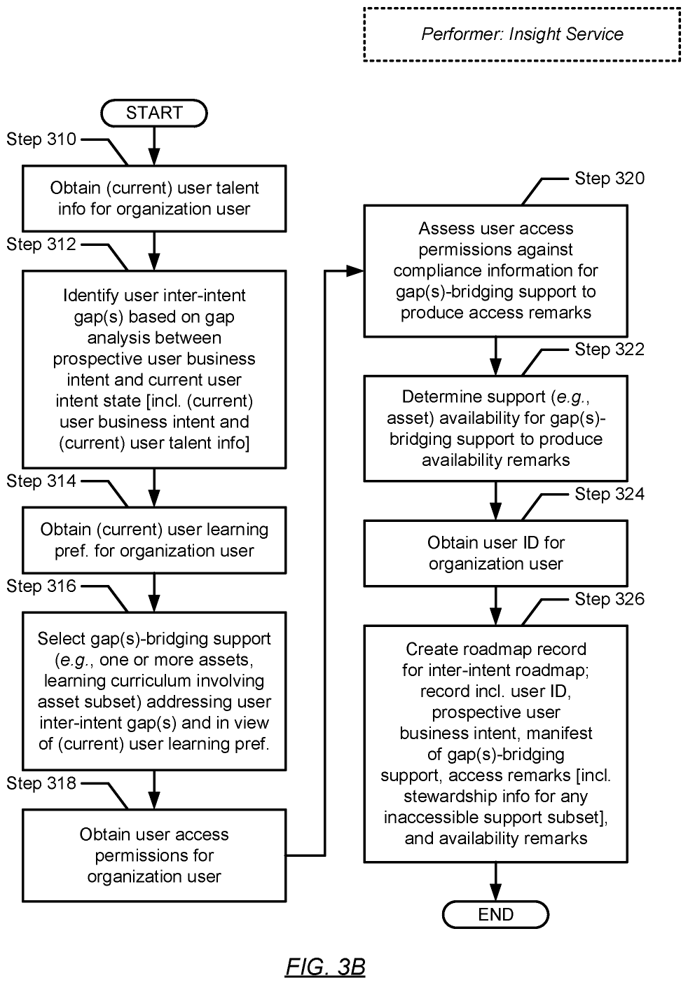

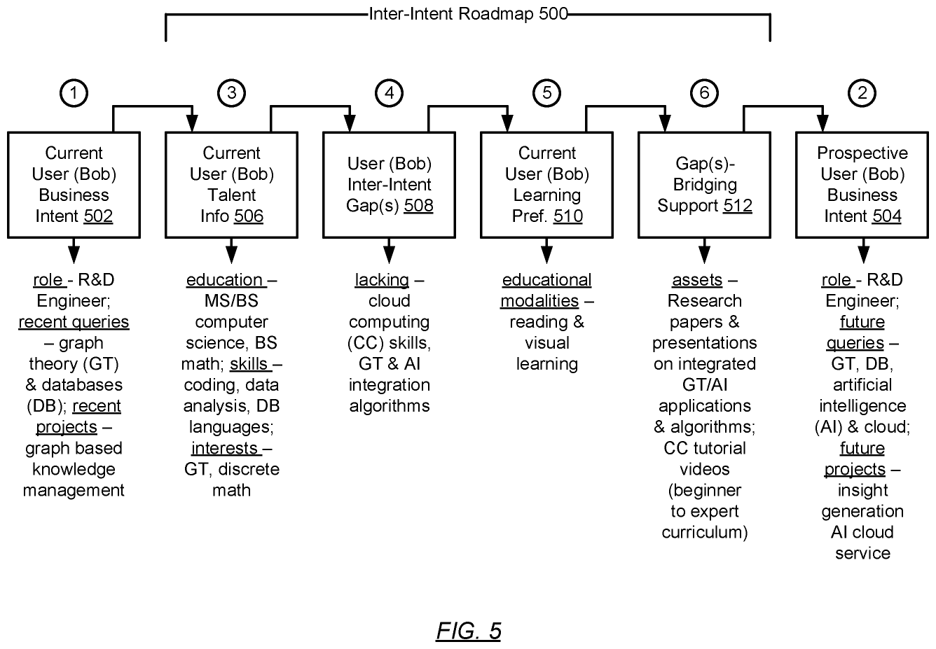

In one or many embodiment(s) disclosed herein, the insight service (106) may be configured with various capabilities or functionalities directed to digitally-assisted organization strategy. Said capabilities/functionalities may include: prediction of and support readiness for future business intents, as described in FIGS. 3A and 3B as well as exemplified in FIG. 5, below. Further, the insight service (106) may perform other capabilities/functionalities without departing from the scope disclosed herein.

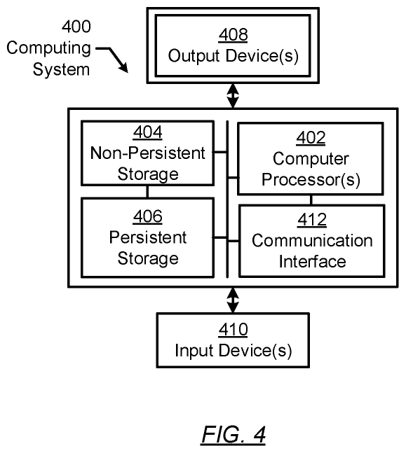

In one or many embodiment(s) disclosed herein, the insight service (106) may be implemented through on-premises infrastructure, cloud computing infrastructure, or any hybrid infrastructure thereof. The insight service (106), accordingly, may be implemented using one or more network servers (not shown), where each network server may represent a physical or a virtual network server. Additionally, or alternatively, the insight service (106) may be implemented using one or more computing systems each similar to the example computing system shown and described with respect to FIG. 4, below.

In one or many embodiment(s) disclosed herein, a client device (108) may represent any physical appliance or computing system operated by one or more organization users and configured to receive, generate, process, store, and/or transmit data/information (e.g., assets), as well as to provide an environment in which one or more computer programs (e.g., applications, insight agents, etc.) may execute thereon. An organization user, briefly, may refer to any individual whom is affiliated with, and fulfills one or more roles pertaining to, the organization that serves as the proprietor of the organization-internal environment (102). Further, in providing an execution environment for any computer programs, a client device (108) may include and allocate various resources (e.g., computer processors, memory, storage, virtualization, network bandwidth, etc.), as needed, to the computer programs and the tasks (or processes) instantiated thereby. Examples of a client device (108) may include, but are not limited to, a desktop computer, a laptop computer, a tablet computer, a smartphone, or any other computing system similar to the example computing system shown and described with respect to FIG. 4, below. Moreover, any client device (108) is described in further detail through FIG. 1B, below.

In one or many embodiment(s) disclosed herein, the organization-external environment (110) may represent any number of digital (e.g., IT) ecosystems not belonging to, and thus not managed by, an/the organization serving as the proprietor of the organization-internal environment (102). The organization-external environment (110), accordingly, may at least reference any public networks including any respective service(s) and data/information (e.g., assets). Further, the organization-external environment (110) may include one or more external data sources (112) and one or more third-party services (114). Each of these organization-external environment (110) subcomponents may or may not be co-located, and thus reside and/or operate, in the same physical or geographical space. Moreover, each of these organization-external environment (110) subcomponents is described below.

In one or many embodiment(s) disclosed herein, an external data source (112) may represent any data source (described above) not belonging to, and thus not managed by, an/the organization serving as the proprietor of the organization-internal environment (102). Any external data source (112), more specially, may refer to a location that stores at least a portion of the asset(s) found across any public networks. Further, depending on their respective access permissions, entities within the organization-internal environment (102), as well as those throughout the organization-external environment (110), may or may not be permitted to access any external data source (104) and, therefore, may or may not be permitted to access any asset(s) maintained therein.

Moreover, in one or many embodiment(s) disclosed herein, any external data source (112) may be implemented as physical storage (and/or as logical/virtual storage spanning at least a portion of the physical storage). The physical storage may, at least in part, include persistent storage, where examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one or many embodiment(s) disclosed herein, a third party service (114) may represent information technology infrastructure configured for any number of purposes and/or applications. A third party, whom may implement and manage one or more third party services (114), may refer to an individual, a group of individuals, or another organization (i.e., not the organization serving as the proprietor of the organization-internal environment (102)) that serves as the proprietor of said third party service(s) (114). By way of an example, one such third party service (114), as disclosed herein may be exemplified by an automated machine learning (ML) service. A purpose of the automated ML service may be directed to automating the selection, composition, and parameterization of ML models. That is, more simply, the automated ML service may be configured to automatically identify one or more optimal ML algorithms from which one or more ML models may be constructed and fit to a submitted dataset in order to best achieve any given set of tasks. Further, any third party service (114) is not limited to the aforementioned specific example.

In one or many embodiment(s) disclosed herein, any third party service (114) may be implemented through on-premises infrastructure, cloud computing infrastructure, or any hybrid infrastructure thereof. Any third party service (114), accordingly, may be implemented using one or more network servers (not shown), where each network server may represent a physical or a virtual network server. Additionally, or alternatively, any third party service (114) may be implemented using one or more computing systems each similar to the example computing system shown and described with respect to FIG. 4, below.

In one or many embodiment(s) disclosed herein, the above-mentioned system (100) components, and their respective subcomponents, may communicate with one another through a network (not shown) (e.g., a local area network (LAN), a wide area network (WAN) such as the Internet, a mobile network, any other communication network type, or a combination thereof). The network may be implemented using any combination of wired and/or wireless connections. Further, the network may encompass various interconnected, network-enabled subcomponents (or systems) (e.g., switches, routers, gateways, etc.) that may facilitate communications between the above-mentioned system (100) components and their respective subcomponents. Moreover, in communicating with one another, the above-mentioned system (100) components, and their respective subcomponents, may employ any combination of existing wired and/or wireless communication protocols.

While FIG. 1A shows a configuration of components and/or subcomponents, other system (100) configurations may be used without departing from the scope disclosed herein.

FIG. 1B shows a client device in accordance with one or more embodiments disclosed herein. The client device (108) (described above as well) (see e.g., FIG. 1A) may host or include one or more applications (116A-116N). Each application (116A-116N), in turn, may host or include an insight agent (118A-118N). Each of these client device (108) subcomponents is described below.

In one or many embodiment(s) disclosed herein, an application (116A-116N) (also referred to herein as a software application or program) may represent a computer program, or a collection of computer instructions, configured to perform one or more specific functions. Broadly, examples of said specific function(s) may include, but are not limited to, receiving, generating and/or modifying, processing and/or analyzing, storing or deleting, and transmitting data/information (e.g., assets) (or at least portions thereof). That is, said specific function(s) may generally entail one or more interactions with data/information either maintained locally on the client device (108) or remotely across one or more data sources. Examples of an application (116A-116N) may include a word processor, a spreadsheet editor, a presentation editor, a database manager, a graphics renderer, a video editor, an audio editor, a web browser, a collaboration tool or platform, and an electronic mail (or email) client. Any application (116A-116N), further, is not limited to the aforementioned specific examples.

In one or many embodiment(s) disclosed herein, any application (116A-116N) may be employed by one or more organization users, which may be operating the client device (108), to achieve one or more tasks, at least in part, contingent on the specific function(s) that the application (116A-116N) may be configured to perform. Said task(s) may or may not be directed to supporting and/or achieving any short-term and/or long-term goal(s) outlined by an/the organization with which the organization user(s) may be affiliated. In one or many embodiment(s) disclosed herein, an insight agent (118A-118N) may represent a computer program, or a collection of computer instructions, configured to perform any number of tasks in support, or as extensions, of the capabilities or functionalities of the insight service (106) (described above) (see e.g., FIG. 1A). With respect to their assigned application (116A-116N), examples of said tasks, which may be carried out by a given insight agent (118A-118N), may include: detecting an initiation of their assigned application (116A-116N) by the organization user(s) operating the client device (108); monitoring any engagement (or interaction), by the organization user(s), with their assigned application (116A-116N) following the detected initiation thereof; identifying certain engagement/interaction actions, performed by the organization user(s), based on said engagement/interaction monitoring; executing any number of procedures or algorithms, relevant to one or more insight service (106) capabilities/functionalities, in response to one or more of the identified certain engagement/interaction actions; providing periodic and/or on-demand telemetry to the insight service (106), where said telemetry may include, for example, data/information requiring processing or analysis to be performed on/by the insight service (106); and receive periodic and/or on-demand updates (and/or instructions) from the insight service (106). Further, the tasks carried out by any insight agent (118A-118N) are not limited to the aforementioned specific examples.

While FIG. 1B shows a configuration of components and/or subcomponents, other client device (108) configurations may be used without departing from the scope disclosed herein. For example, in one or many embodiment(s) disclosed herein, not all of the application(s) (116A-116N), executing on the client device (108), may host or include an insight agent (118A-118N). That is, in said embodiment(s), an insight agent (118A-118N) may not be assigned to or associated with any of at least a subset of the application(s) (116A-116N) installed on the client device (108).

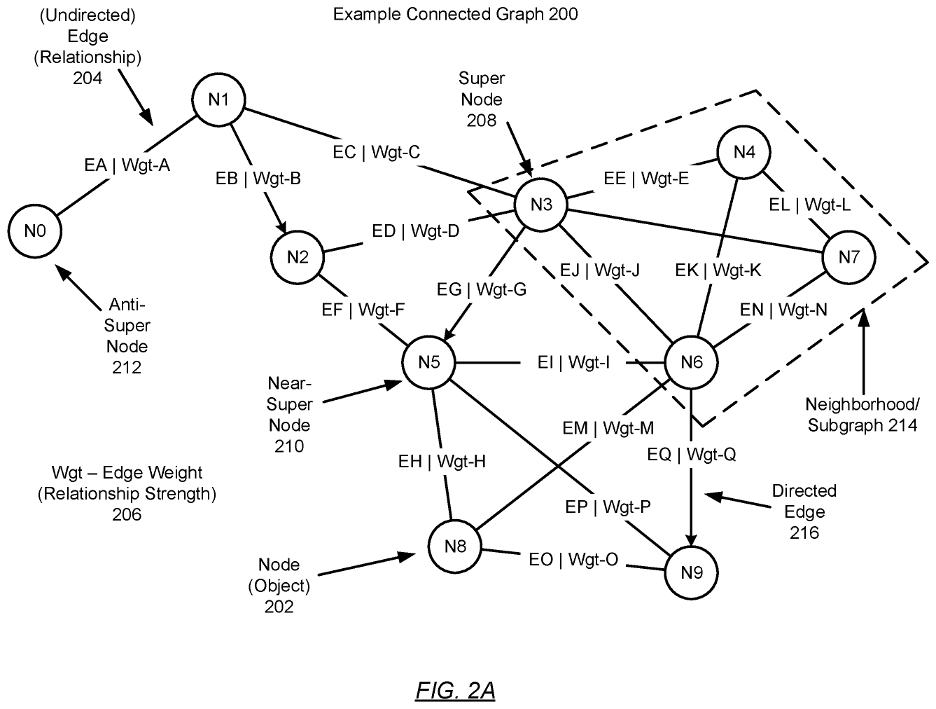

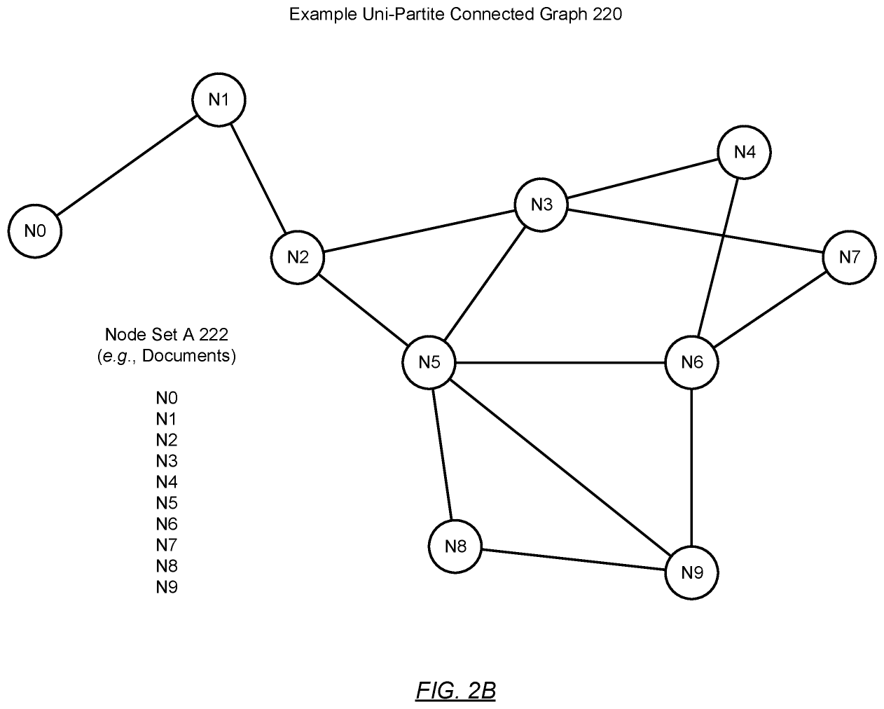

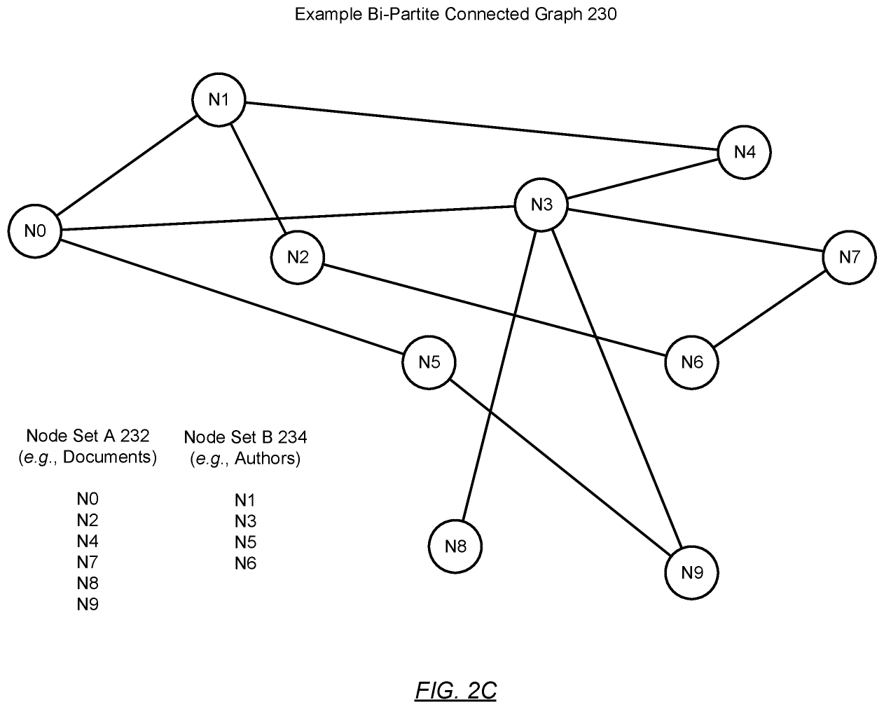

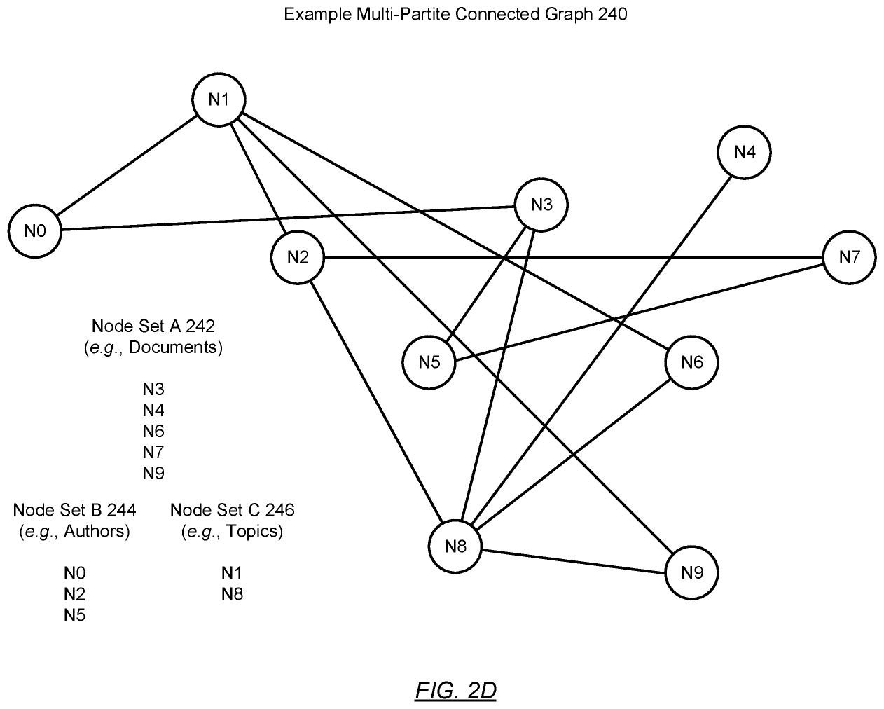

FIG. 2A shows an example connected graph in accordance with one or more embodiments disclosed herein. A connected graph (200), as disclosed herein, may refer to a set of nodes (202) (denoted in the example by the circles labeled N0, N1, N2, . . . , N9) interconnected by a set of edges (204, 216) (denoted in the example by the lines labeled EA, EB, EC, . . . , EQ between pairs of nodes). Each node (202) may represent or correspond to an object (e.g., a catalog entry, a record, specific data/information, a person, etc.) whereas each edge (204, 216), between or connecting any pair of nodes, may represent or correspond to a relationship, or relationships, associating the objects mapped to the pair of nodes. A connected graph (200), accordingly, may reference a data structure that reflects associations amongst any number, or a collection, of objects.

In one or many embodiment(s) disclosed herein, each node (202), in a connected graph (200), may also be referred to herein, and thus may serve, as an endpoint (of a pair of endpoints) of/to at least one edge (204). Further, based on a number of edges connected thereto, any node (202), in a connected graph (200), may be designated or identified as a super node (208), a near-super node (210), or an anti-super node (212). A super node (208) may reference any node where the number of edges, connected thereto, meets or exceeds a (high) threshold number of edges (e.g., six (6) edges). A near-super node (210), meanwhile, may reference any node where the number of edges, connected thereto, meets or exceeds a first (high) threshold number of edges (e.g., five (5) edges) yet lies below a second (higher) threshold number of edges (e.g., six (6) edges), where said second threshold number of edges defines the criterion for designating/identifying a super node (208). Lastly, an anti-super node (212) may reference any node where the number of edges, connected thereto, lies below a (low) threshold number of edges (e.g., two (2) edges).

In one or many embodiment(s) disclosed herein, each edge (204, 216), in a connected graph (200), may either be designated or identified as an undirected edge (204) or, conversely, as a directed edge (216). An undirected edge (204) may reference any edge specifying a bidirectional relationship between objects mapped to the pair of endpoints (i.e., pair of nodes (202)) connected by the edge. A directed edge (216), on the other hand, may reference any edge specifying a unidirectional relationship between objects mapped to the pair of endpoints connected by the edge.

In one or many embodiment(s) disclosed herein, each edge (204, 216), in a connected graph (200), may be associated with or assigned an edge weight (206) (denoted in the example by the labels Wgt-A, Wgt-B, Wgt-C, . . . , Wgt-Q). An edge weight (206), of a given edge (204, 216), may reflect a strength of the relationship(s) represented by the given edge (204, 216). Further, any edge weight (206) may be expressed as or through a positive numerical value within a predefined spectrum or range of positive numerical values (e.g., 0.1 to 1.0, 1 to 100, etc.). Moreover, across the said predefined spectrum/range of positive numerical values, higher positive numerical values may reflect stronger relationships, while lower positive numerical values may alternatively reflect weaker relationships.

In one or many embodiment(s) disclosed herein, based on an edge weight (206) associated with or assigned to an edge (204, 216) connected thereto, any node (202), in a connected graph (200), may be designated or identified as a strong adjacent node (not shown) or a weak adjacent node (not shown) with respect to the other endpoint of (i.e., the other node connected to the node (202) through) the edge (204, 216). That is, a strong adjacent node may reference any node of a pair of nodes connected by an edge, where an edge weight of the edge meets or exceeds a (high) edge weight threshold. Alternatively, a weak adjacent node may reference any node of a pair of nodes connected by an edge, where an edge weight of the edge lies below a (low) edge weight threshold.

In one or many embodiment(s) disclosed herein, a connected graph (200) may include one or more subgraphs (214) (also referred to as neighborhoods). A subgraph (214) may refer to a smaller connected graph found within a (larger) connected graph (200). A subgraph (214), accordingly, may include a node subset of the set of nodes (202), and an edge subset of the set of edges (204, 216), that form a connected graph (200), where the edge subset interconnects the node subset.

While FIG. 2A shows a configuration of components and/or subcomponents, other connected graph (200) configurations may be used without departing from the scope disclosed herein.

FIGS. 2B-2D show example k-partite connected graphs in accordance with one or more embodiments disclosed herein. Generally, any k-partite connected graph may represent a connected graph (described above) (see e.g., FIG. 2A) that encompasses k independent sets of nodes and a set of edges interconnecting (and thus defining relationships between) pairs of nodes: (a) both belonging to the same, single independent set of nodes in any (k=1)-partite connected graph; or (b) each belonging to a different independent set of nodes in any (k>1)-partite connected graph. Further, any k-partite connected graph, as disclosed herein, may fall into one of three possible classifications: (a) a uni-partite connected graph, where k=1; (b) a bi-partite connected graph, where k=2; or (c) a multi-partite connected graph, where k≥3.

Turning to FIG. 2B, an example uni-partite connected graph (220) is depicted. The uni-partite connected graph (220) includes one (k=1) independent set of nodes—i.e., a node set (222), which collectively maps or belongs to a single object class (e.g., documents).

Further, in the example, the node set is denoted by the circles labeled N0, N1, N2, . . . , N9. Each said circle, in the node set (222), subsequently denotes a node that represents or corresponds to a given object (e.g., a document) in a collection of objects (e.g., a group of documents) of the same object class (e.g., documents).

Moreover, the uni-partite connected graph (220) additionally includes a set of edges (denoted in the example by the lines interconnecting pairs of nodes, where the first and second nodes in a given node pair belongs to the node set (222)). Each edge, in the example, thus reflects a relationship, or relationships, between any two nodes of the node set (222) (and, by association, any two objects of the same object class) directly connected via the edge.

Turning to FIG. 2C, an example bi-partite connected graph (230) is depicted. The bi-partite connected graph (230) includes two (k=2) independent sets of nodes—i.e., a first node set (232) and a second node set (234), where the former collectively maps or belongs to a first object class (e.g., documents) whereas the latter collectively maps or belongs to a second object class (e.g., authors).

Further, in the example, the first node set (232) is denoted by the circles labeled N0, N2, N4, N7, N8, and N9, while the second node set (234) is denoted by the circles labeled N1, N3, N5, and N6. Each circle, in the first node set (232), subsequently denotes a node that represents or corresponds to a given first object (e.g., a document) in a collection of first objects (e.g., a group of documents) of the first object class (e.g., documents). Meanwhile, each circle, in the second node set (234), subsequently denotes a node that represents or corresponds to a given second object (e.g., an author) in a collection of second objects (e.g., a group of authors) of the second object class (e.g., authors).

Moreover, the bi-partite connected graph (230) additionally includes a set of edges (denoted in the example by the lines interconnecting pairs of nodes, where a first node in a given node pair belongs to the first node set (232) and a second node in the given node pair belongs to the second node set (234)). Each edge, in the example, thus reflects a relationship, or relationships, between any one node of the first node set (232) and any one node of the second node set (234) (and, by association, any one object of the first object class and any one object of the second object class) directly connected via the edge.

Turning to FIG. 2D, an example multi-partite connected graph (240) is depicted. The multi-partite connected graph (240) includes three (k=3) independent sets of nodes—i.e., a first node set (242), a second node set (244), and a third node set (246). The first node set (242) collectively maps or belongs to a first object class (e.g., documents); the second node set (244) collectively maps or belongs to a second object class (e.g., authors); and the third node set (246) collectively maps or belongs to a third object class (e.g., topics).

Further, in the example, the first node set (242) is denoted by the circles labeled N3, N4, N6, N7, and N9; the second node set (244) is denoted by the circles labeled N0, N2, and N5; and the third node set (246) is denoted by the circles labeled N1 and N8. Each circle, in the first node set (242), subsequently denotes a node that represents or corresponds to a given first object (e.g., a document) in a collection of first objects (e.g., a group of documents) of the first object class (e.g., documents). Meanwhile, each circle, in the second node set (244), subsequently denotes a node that represents or corresponds to a given second object (e.g., an author) in a collection of second objects (e.g., a group of authors) of the second object class (e.g., authors). Lastly, each circle, in the third node set (246), subsequently denotes a node that represents or corresponds to a given third object (e.g., a topic) in a collection of third objects (e.g., a group of topics) of the third object class (e.g., topics).

Moreover, the multi-partite connected graph (240) additionally includes a set of edges (denoted in the example by the lines interconnecting pairs of nodes, where a first node in a given node pair belongs to one object class from the three available object classes, and a second node in the given node pair belongs to another object class from the two remaining object classes (that excludes the one object class to which the first node in the given node pair belongs)). Each edge, in the example, thus reflects a relationship, or relationships, between any one node of one object class (from the three available object classes) and any one node of another object class (from the two remaining object class excluding the one object class) directly connected via the edge.

FIG. 3A shows a flowchart describing a method for the prediction of and support readiness for future business intents in accordance with one or more embodiments disclosed herein. The various steps outlined below may be performed by an insight service (see e.g., FIG. 1A). Further, while the various steps in the flowchart are presented and described sequentially, one of ordinary skill will appreciate that some or all steps may be executed in different orders, may be combined or omitted, and some or all steps may be executed in parallel.

Turning to FIG. 3A, in Step 300, an organization user is identified. In one or many embodiment(s) disclosed herein, the organization user may refer to an individual whom may be employed by, or may otherwise be affiliated with, an organization. Examples of said organization may include, but are not limited to, a business/commercial entity, a higher education school, a government agency, and a research institute. Further, the organization user may be identified at random or based on an identification criterion (e.g., detection of the recent completion of an organization goal assigned to and by the organization user).

In Step 302, a (current) user business intent is obtained. In one or many embodiment(s) disclosed herein, the (current) user business intent may pertain to the organization user (identified in Step 300). Further, the user business intent may refer to information, respective to the organization user, which may pertain to or describe the engagement of the organization user within and/or outside their organization.

In one or many embodiment(s) disclosed herein, the (current) user business intent, moreover, may be represented through a set of business intent parameters. Examples of said business intent parameter(s) (as they pertain to any given organization user) may include, but is/are not limited to: one or more user organization roles (e.g., title(s) and/or position(s)) within an organization that may be associated with the given organization user; one or more other organization users within the organization with which the given organization user interacts and/or had interacted; one or more suppliers, distributors, customers, collaborators, and/or other actors outside the organization (also collectively referred to herein as one or more value networks) with which the given organization user interacts and/or had interacted; a search query history reflecting one or more past search queries, as well as the search topic(s) entailed, which had been previously submitted by the given organization user; one or more organization departments of the organization with which the given organization user is associated; one or more organization responsibilities (e.g., assigned project(s) or task(s)) within the organization that the given organization user is currently undertaking or had undertaken in the past; and one or more success metrics indicating a level of success that the aforementioned organization responsibility/responsibilities have brought to the organization. Said business intent parameter(s) is/are not limited to the aforementioned specific examples.

In Step 304, one or more intent predictive models is/are built. In one or many embodiment(s) disclosed herein, any intent predictive model may refer to a machine learning based analytical computer program designed and configured to forecast, or extrapolate, future or prospective user business intents (described below). Further, building of any intent predictive model may follow existing methodologies for creating a machine learning model, including, for example: selecting a machine learning algorithm (e.g., neural networks, decision trees, random forests, linear/logistic regression, support vector machines, etc.) to serve as a template for the machine learning model; optimizing, through one or more iterations of training, the parameters and/or hyper-parameters specific to the selected machine learning algorithm using one or more training datasets; and obtaining the machine learning model defined by the optimized parameters and/or hyper-parameters post-training.

In Step 306, one or more prospective user business intents, for the organization user (identified in Step 300), is/are extrapolated. In one or many embodiment(s) disclosed herein, any prospective user business intent may refer to information, respective to the organization user, which may outline a possible or potential evolution in one or more business intent parameters (described above) representing the (current) user business intent (obtained in Step 302). For example, a prospective user business intent may include predictions concerning future search queries that may be (or have a high likelihood of being) submitted by the organization user in one or more future points-in-time based at least on the search query history associated with the organization user. By way of another example, a prospective user business intent may include predictions concerning future organization responsibilities (e.g., future projects, tasks, and/or goals) that may be (or have a high likelihood of being) undertaken by the organization user in one or more future points-in-time based at least on past and/or current organization responsibilities undertaken by the organization user and any historical and/or recent organization strategy cascade(s).

Further, in one or many embodiment(s) disclosed herein, extrapolation of the prospective user business intent(s) may result from usage of the intent predictive model(s) (built in Step 304) —the intent predictive model(s) being configured to: ingest, and subsequently identify patterns throughout, the (current) user business intent; and forecast, or extrapolate, future or prospective user business intent(s) based on the identified patterns. Should more than one intent predictive model be used, said two or more intent predictive models may be assembled into an intent predictive model pipeline reflecting a series of data processing stages. Each data processing stage may involve one of the at least two intent predictive models being employed. Moreover, each data processing stage may use the output of a previous data processing stage in the series (if any) as input to be processed, by the involved intent predictive model, in order to produce an output for the data processing stage. For example: the input(s) for a first data processing stage may include the (current) user business intent, which may be processed by a first intent predictive model to obtain a first stage output; the input(s) for a second data processing stage may include the first stage output, which may be processed by a second intent predictive model to obtain a second stage output; and so forth. The stage output, for a last data processing stage in the series, may include any future/prospective user business intent(s).

In Step 308, for each prospective user business intent of the prospective user business intent(s) (extrapolated in Step 306), an inter-intent roadmap is pursued. In one or many embodiment(s) disclosed herein, the inter-intent roadmap may refer to a readiness pipeline for supporting the prospective user business intent, which uses the (current) user business intent (obtained in Step 302) as a baseline or starting point. The readiness pipeline, in turn, may outline a series of inter-intent bridging steps aiming to achieve the prospective user business intent, from said baseline, should the organization user actually embark in the prospective user business intent at any given future point-in-time. Pursuit of the inter-intent roadmap is illustrated and described in further detail with respect to FIG. 3B, below.

FIG. 3B shows a flowchart describing a method for pursuing an inter-intent roadmap in accordance with one or more embodiments disclosed herein. The various steps outlined below may be performed by an insight service (see e.g., FIG. 1A). Further, while the various steps in the flowchart are presented and described sequentially, one of ordinary skill will appreciate that some or all steps may be executed in different orders, may be combined or omitted, and some or all steps may be executed in parallel.

Turning to FIG. 3B, in Step 310, (current) user talent information is obtained. In one or many embodiment(s) disclosed herein, the (current) user talent information may pertain to an organization user (identified in FIG. 3A—see e.g. Step 300). Further, the (current) user talent information may reflect a compilation of talent- and development-related details associated with the organization user. Examples of said details may include, but are not limited to: an education level (e.g., degree(s) in which domain(s), as well as which tier(s) of degree(s)) earned by the organization user; any professional certification(s) gained by the organization user; one or more competencies (as well as their respective level(s) and/or potential(s)) characterizing the organization user; and any business- or research-related interest(s) (as well as their respective proficiency/proficiencies) expressed by the organization user. The compiled details defining the user talent information for any given organization user are not limited to the aforementioned specific examples.

In Step 312, one or more user inter-intent gaps is/are identified. In one or many embodiment(s) disclosed herein, a user inter-intent gap may refer to an inferred differentiator (e.g., what is lacking) between the prospective user business intent and a current user intent state for the organization user. The prospective user business intent may refer to one of the prospective user business intent(s) (extrapolated in FIG. 3A—see e.g., Step 306) for which support is being readied through pursuit of an inter-intent roadmap outlined by the instant method. Meanwhile, the current user intent state may collectively reference a (current) user business intent (obtained in FIG. 3A—see e.g., Step 302) and the (current) user talent information (obtained in Step 310). Furthermore, identification of the user inter-intent gap(s) may result, for example, from any existing algorithm(s) directed to gap or needs analysis, and that may be applied between the prospective user business intent and the current user intent state.

In Step 314, (current) user learning preferences are obtained. In one or many embodiment(s) disclosed herein, the (current) user learning preferences may pertain to the organization user (identified in FIG. 3A—see e.g., Step 300). Further, the (current) user learning preferences may reflect one or more educational modalities that the organization user may favor over others in order to optimize learning topic comprehension and retention. Said educational modality/modalities may include, but is/are not limited to, visual learning (i.e., learning assisted through images, videos, animations, and/or multimedia), auditory learning (i.e., learning assisted through audio), and reading learning (i.e., learning assisted through text-based content).

In Step 316, gap-bridging support is selected. In one or many embodiment(s) disclosed herein, the gap-bridging support may include one or more assets (e.g., structured information such as tabular data, and/or unstructured information such as text, images, audio, videos, multimedia, etc.) catalogued by, and thus known to, the insight service. Further, the asset(s) may be selected such that they (separately or in combination) discuss, or otherwise capture, one or more topics or domains that address the user inter-intent gap(s) (identified in Step 312); and such that they (each) match or align with the (current) user learning preferences (obtained in Step 314).

In one or many embodiment(s) disclosed herein, any asset catalogued by, and thus known to, the insight service may be recorded in an asset catalog entry of an asset catalog. An asset catalog entry, for any given asset, may store metadata for, or information descriptive of, the given asset.

Examples of said asset metadata may include, but is not limited to: a brief description of the asset; stewardship (or ownership) information (e.g., individual or group name(s), contact information, etc.) pertaining to the steward(s)/owner(s) of the asset; a version character string reflective of a version or state of the asset at/for a given point-in-time; one or more categories, topics, and/or aspects associated with the asset; an asset identifier uniquely identifying the asset; one or more tags, keywords, or terms further describing the asset; a source identifier and/or location associated with an internal or external data source (see e.g., FIG. 1A) where the asset resides or is maintained; and compliance information specifying laws, regulations, and standards surrounding the asset, as well as policies directed to data governance (e.g., availability, usability, integrity, and security) pertinent to the asset. The asset metadata for any asset is not limited to the aforementioned specific examples.

In one or many other embodiment(s) disclosed herein, the gap-bridging support may additionally, or alternatively, include a learning curriculum. The learning curriculum may refer to an ordered itemization/listing (or sequenced itemization/listing) of learning materials and/or content (i.e., collectively, one or more assets) that progressively teaches improved proficiency in one or more given learning topics. Each learning topic may, at least in part, address the user inter-intent gap(s) (identified in Step 312). The learning curriculum, further, may be tailored to, and therefore may align with the (current) user talent information (obtained in Step 310) and/or the (current) user learning preferences (obtained in Step 314).

That is, in one or many embodiment(s) disclosed herein, the learning curriculum may reflect a series, or an ordered set, of assets that teach progressively more difficult or more advanced aspects of the learning topic(s) sought to overcome the user inter-intent gap(s) (identified in Step 312). For example, an initially ordered asset specified in the learning curriculum may be commensurate to a novice/basic knowledge level or, alternatively, a standing/current knowledge level that the organization user may retain, concerning the learning topic(s). On the other hand, a lastly ordered asset specified in the learning curriculum may be representative of a mastery knowledge level concerning the learning topic(s). Further, any asset ordered there-between may serve to progressively advance the proficiency, of/by the organization user, in terms of the learning topic(s).

In Step 318, user access permissions are obtained. In one or many embodiment(s) disclosed herein, the user access permissions may pertain to the organization user (identified in FIG. 3A—see e.g., Step 300). Further, the user access permissions may reflect the level of authorization granted to the organization user for accessing specific resources. The granted level of authorization, for any given organization user, may, for example, be contingent on any number of factors, which may include, but is/are not limited to: one or more user organization roles (e.g., title(s) and/or position(s)) within an organization that may be associated with the given organization user; one or more organization responsibilities (e.g., assigned project(s) or task(s)) within an organization that may be associated with the given organization user; a client device (and the security hygiene or characteristics thereof) operated by the given organization user; and a geographical location where the given organization user may be physically situated. The factor(s) affecting the user access permissions for any given organization user is/are not limited to the aforementioned specific examples.

In Step 320, the user access permissions (obtained in Step 318) are assessed against compliance information for the gap-bridging support (or more specifically, the forming set of assets) (selected in Step 316). In one or many embodiment(s) disclosed herein, assessment of the user access permissions, against the asset compliance information, may, for example, entail determining: whether a geographical location of the organization user is within the geographical restrictions or boundaries, at least in part, defining access to an asset; whether the organization, with which the organization user is associated, is of a particular type (e.g., a commercial business, an educational institution, etc.) to which access and usability of an asset is granted; and whether one or more organization roles (e.g., title(s) and/or position(s)) and/or professional affiliation(s) (e.g., membership(s) to professional organization(s)), with which the organization user is associated, satisfies criteria for permitting access to an asset.

Moreover, the above-mentioned assessment, between the user access permissions and the asset compliance information, may result in producing access remarks that concern the asset(s) associated with the compliance information. In one or many embodiment(s) disclosed herein, any access remarks may refer to information expressing whether the asset(s) is/are accessible or inaccessible to/by the organization user. Said information (for any given asset) may include, but is not limited to: an accessibility statement indicating that the given asset can or cannot be accessed by the organization user; one or more reasons explaining or supporting the accessibility statement; a digital reference link (e.g., uniform resource locator or hyperlink) or an access protocol through which the organization user can access the given asset should the accessibility statement indicate that the given asset can be accessed by the organization user; and/or the stewardship information (mentioned in Step 316) associated with the given asset should the accessibility statement alternatively indicate that the given asset cannot be accessed by the organization user.

In one or many embodiment(s) disclosed herein, stewardship information may be integrated, as part of the access remarks for a given asset (if applicable—e.g., if the given asset is deemed inaccessible), in order to provide the organization user with an opportunity to potentially gain access to the given asset through communications with the steward(s) or owner(s) of the given asset. The potential to gain access to the given asset through this avenue, however, may be moot or disregarded in view of other, higher-tiered compliance policies such as those outlined by geographical restrictions, as well as national and/or international laws, regulations, and standards.

In Step 322, a support availability is determined. In one or many embodiment(s) disclosed herein, the support availability may pertain to the gap-bridging support (or more specifically, the forming set of assets) (selected in Step 316). Further, the determination of support (e.g., asset) availability for any given asset may, for example, entail the submission of an asset availability query to an appropriate (i.e., internal or external) data source identified in the asset metadata describing the given asset. Any asset availability query may include or specify an asset identifier (also found in the asset metadata) that uniquely identifies the given asset. Moreover, in response to any asset availability query, a corresponding asset availability reply may be received, which may include or specify an asset availability state indicating whether the given asset is available (e.g., obtainable, usable, or reachable) or unavailable (e.g., unobtainable, unusable, or unreachable). Thereafter, the returned asset availability state(s) for the asset(s), respectively, may be used to produce availability remarks concerning the asset(s). Any availability remarks may refer to information expressing whether the asset(s) is/are available or unavailable at/on one or more data sources that the asset(s) currently reside, or at one time, had resided.

In Step 324, a user identifier (ID) is obtained. In one or many embodiment(s) disclosed herein, the user ID may pertain to the organization user (identified in FIG. 3A—see e.g., Step 300). Further, the user ID may reflect a character string that uniquely identifies the organization user. The character string may be of any arbitrary length and may be formed from any combination or order of characters, where the characters may include, but are not limited to, one or more letters, one or more numbers, and/or one or more symbols.

In Step 326, a roadmap record is created (and subsequently stored). In one or many embodiment(s) disclosed herein, the roadmap record may be exemplified by a database entry, an information container, or a data directory (for maintaining information across one or more data files). Further, the roadmap record may include: the user ID (obtained in Step 324); the prospective user business intent (i.e., one of the prospective user business intent(s) (extrapolated in FIG. 3A—see e.g., Step 306)) for which support is being readied through pursuit of an inter-intent roadmap outlined by the instant method; a manifest of, and thus listing, the gap-bridging support (selected in Step 316); the access remarks (produced in Step 320); and the availability remarks (produced in Step 322).

FIG. 4 shows an example computing system in accordance with one or more embodiments disclosed herein. The computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment disclosed herein, the computer processor(s) (402) may be an integrated circuit for processing instructions. For example, the computer processor(s) may be one or more cores or micro-cores of a central processing unit (CPU) and/or a graphics processing unit (GPU). The computing system (400) may also include one or more input devices (410), such as a touchscreen, keyboard, mouse, microphone, touchpad, electronic pen, or any other type of input device. Further, the communication interface (412) may include an integrated circuit for connecting the computing system (400) to a network (not shown) (e.g., a local area network (LAN), a wide area network (WAN) such as the Internet, mobile network, or any other type of network) and/or to another device, such as another computing device.

In one embodiment disclosed herein, the computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing systems exist, and the aforementioned input and output device(s) may take other forms.

Software instructions in the form of computer readable program code to perform embodiments disclosed herein may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments disclosed herein.

FIG. 5 shows an example scenario in accordance with one or more embodiments disclosed herein. The example scenario, illustrated through FIG. 5 and described below, is for explanatory purposes only and not intended to limit the scope disclosed herein.

Hereinafter, consider the following example scenario whereby the disclosed capability of predicting, and providing readiness support for, future business intents is applied, by the Insight Service, to circumstances entailing an organization user identified as Bob.

To that end, and following embodiments herein pertaining to said disclosed capability, the Insight Service, foremost, obtains a current user business intent (502) associated with Bob. The obtained current user business intent (502) at least specifies that Bob: (a) is a research and development (R&D) engineer for/at the organization with which Bob is affiliated; (b) has made recent search queries relating to graph theory (GT), databases (DB), and/or a combination thereof; and (c) has recently completed a project directed to graph based knowledge management.

Based on the obtained current user business intent for Bob, the Insight Service proceeds to build one or more intent predictive models. The intent predictive model(s) is/are subsequently used to extrapolate a prospective user business intent (504) for Bob. The extrapolated prospective user business intent (504) includes the following predictions: (a) that Bob, at some future point-in-time, may submit one or more search queries relating to GT, DB, artificial intelligence (AI), cloud computing (CC), and/or any combination(s) thereof; and (b) that Bob, at some future point-in-time, may be assigned or undertake a project directed to developing a cloud computing service implementing an AI capable of insight generation.

With the obtained current user business intent (502) and the extrapolated prospective user business intent (504) at hand, the Insight Service thereafter pursues an inter-intent roadmap (500) in order to ready support, to Bob, should Bob follow in the predictions specified by the extrapolated prospective user business intent (504) at some future point-in-time.

Accordingly, as an initial step along the inter-intent roadmap (500), the Insight Service obtains current user talent information (506) associated with Bob. The obtained current user talent information (506) at least specifies that Bob: (a) has earned undergraduate degrees in computer science and mathematics, as well as a graduate degree in the former; (b) has skills or proficiencies in coding, data analysis, and DB languages; and (c) has interests, whether professional and/or personal, directed to GT and discrete mathematics.

Next, the Insight Service identifies multiple user inter-intent gaps (508) differentiating the extrapolated prospective user business intent (504) from a current user intent state (or collectively, the obtained current user business intent (502) and the obtained current talent information (506)) for Bob. The identified user inter-intent gaps (508) at least specify that Bob is lacking: (a) CC skills to successfully develop the cloud computing service representative of the future project Bob may be assigned or undertake; and (b) algorithmic knowledge integrating GT and AI to successfully implement the insight generating AI to be provided by the cloud computing service.

From here, the Insight Service obtains current user learning preferences (510) associated with Bob. The obtained current user learning preferences (510) at least specify that Bob has a higher affinity for comprehending and retaining information formatted in the reading and visual learning modalities.

In view of the obtained current user learning preferences (510), the Insight Service then selects the gap-bridging support (512) that would aid Bob should Bob follow in the predictions specified by the extrapolated prospective user business intent (504) at some future point-in-time. The selected gap-bridging support (512) includes: (a) a collection of research papers and slide presentations discussing integrated GT/AI applications and algorithms; and (b) a series of CC tutorial videos representative of a tailored learning curriculum from a beginner level to an expert level of understanding.

While the embodiments disclosed herein have been described with respect to a limited number of embodiments, those skilled in the art, having benefit of this disclosure, will appreciate that other embodiments can be devised which do not depart from the scope disclosed herein as disclosed herein. Accordingly, the scope disclosed herein should be limited only by the attached claims.

What is claimed is:

1. A method for extrapolating prospective user business intents, the method comprising:
identifying an organization user;
obtaining a user business intent for the organization user;
building an intent predictive model based on the user business intent;
extrapolating, using the intent predictive model, a prospective user business intent for the organization user; and
pursuing an inter-intent roadmap for the prospective user business intent.

2. The method of claim 1, wherein the inter-intent roadmap outlines a readiness pipeline for supporting the prospective user business intent.

3. The method of claim 1, wherein pursuing the inter-intent roadmap for the prospective user business intent, comprises:
obtaining user talent information for the organization user; and
identifying at least one user inter-intent gap between a current user intent state for the organization user and the prospective user business intent,
wherein the current user intent state comprises the user business intent and the user talent information.

4. The method of claim 3, wherein the at least one inter-intent gap is identified through gap analysis.

5. The method of claim 3, wherein pursuing the inter-intent roadmap for the prospective user business intent, further comprises:
obtaining user learning preferences for the organization user; and
selecting gap-bridging support addressing the at least one user inter-intent gap and in view of the user learning preferences.

6. The method of claim 5, wherein the gap-bridging support comprises a set of assets.

7. The method of claim 6, wherein the gap-bridging support further comprises a learning curriculum involving an asset subset of the set of assets.

8. The method of claim 5, wherein pursuing the inter-intent roadmap for the prospective user business intent, further comprises:
obtaining user access permissions for the organization user;
assessing the user access permissions against compliance information for the gap-bridging support to produce access remarks; and
determining a support availability for the gap-bridging support to produce availability remarks.

9. The method of claim 8, wherein pursuing the inter-intent roadmap for the prospective user business intent, further comprises:
obtaining a user identifier (ID) for the organization user; and
creating, for the inter-intent roadmap, a roadmap record comprising the user ID, the prospective user business intent, a manifest listing the gap-bridging support, the access remarks, and the availability remarks.

10. The method of claim 1, wherein the intent predictive model further extrapolates a second prospective user business intent, wherein the method further comprises:
pursuing a second inter-intent roadmap for the second prospective user business intent.

11. A non-transitory computer readable medium (CRM) comprising computer readable program code, which when executed by a computer processor, enables the computer processor to perform a method for extrapolating prospective user business intents, the method comprising:
identifying an organization user;
obtaining a user business intent for the organization user;
building an intent predictive model based on the user business intent;
extrapolating, using the intent predictive model, a prospective user business intent for the organization user; and
pursuing an inter-intent roadmap for the prospective user business intent.

12. The non-transitory CRM of claim 11, wherein the inter-intent roadmap outlines a readiness pipeline for supporting the prospective user business intent.

13. The non-transitory CRM of claim 11, wherein pursuing the inter-intent roadmap for the prospective user business intent, comprises:
obtaining user talent information for the organization user; and
identifying at least one user inter-intent gap between a current user intent state for the organization user and the prospective user business intent,
wherein the current user intent state comprises the user business intent and the user talent information.

14. The non-transitory CRM of claim 13, wherein the at least one inter-intent gap is identified through gap analysis.

15. The non-transitory CRM of claim 13, wherein pursuing the inter-intent roadmap for the prospective user business intent, further comprises:
obtaining user learning preferences for the organization user; and
selecting gap-bridging support addressing the at least one user inter-intent gap and in view of the user learning preferences.

16. The non-transitory CRM of claim 15, wherein the gap-bridging support comprises a set of assets.

17. The non-transitory CRM of claim 16, wherein the gap-bridging support further comprises a learning curriculum involving an asset subset of the set of assets.

18. The non-transitory CRM of claim 15, wherein pursuing the inter-intent roadmap for the prospective user business intent, further comprises:
obtaining user access permissions for the organization user;
assessing the user access permissions against compliance information for the gap-bridging support to produce access remarks; and
determining a support availability for the gap-bridging support to produce availability remarks.

19. The non-transitory CRM of claim 18, wherein pursuing the inter-intent roadmap for the prospective user business intent, further comprises:
obtaining a user identifier (ID) for the organization user; and
creating, for the inter-intent roadmap, a roadmap record comprising the user ID, the prospective user business intent, a manifest listing the gap-bridging support, the access remarks, and the availability remarks.

20. A system, the system comprising:
an insight service comprising a computer processor configured to perform a method for extrapolating prospective user business intents, the method comprising:
identifying an organization user;
obtaining a user business intent for the organization user,
building an intent predictive model based on the user business intent;
extrapolating, using the intent predictive model, a prospective user business intent for the organization user; and
pursuing an inter-intent roadmap for the prospective user business intent.
